(19) United States
(12) Patent Application Publication
(10) Pub. No.: US 2021/0093150 A1
(43) Pub. Date: Apr. 1, 2021

(54) ARTIFICIAL INTELLIGENCE DISHWASHER AND DISHWASHING METHOD USING THE SAME

(71) Applicant: LG ELECTRONICS INC., Seoul (KR)

(72) Inventors: Wonho SHIN, Seoul (KR); Beomoh KIM, Seoul (KR); Taehyun KIM, Seoul (KR); Jichan MAENG, Seoul (KR); Jonghoon CHAE, Seoul (KR)

(73) Assignee: LG ELECTRONICS INC., Seoul (KR)

(21) Appl. No.: 16/711,156

(22) Filed: Dec. 11, 2019

(30) Foreign Application Priority Data
Oct. 1, 2019 (KR) 10-2019-0121303

(51) Int. Cl. A47L 15/00; A47L 15/42

(52) U.S. Cl. CPC A47L 15/0028; A47L 15/0007; A47L 15/006; A47L 15/4295; A47L 15/4297; A47L 2501/30; A47L 2401/30; A47L 2401/12; A47L 2401/04; A47L 2601/02; A47L 15/428; A47L 2401/10

(57) ABSTRACT

An artificial intelligence dishwasher including a dish rack on which dishes are arranged, a spray nozzle configured to spray washing water toward the dishes, a washing pump configured to feed washing water stored in a sump to the spray nozzle, a washing motor configured to drive the washing pump, a camera configured to capture the dish rack to obtain a dish arrangement image, and a processor configured to provide the dish arrangement image to a dish recognition model to obtain dish information included in the dish arrangement image, determine a washing cycle for the dishes based on the dish information, and control driving of the washing motor according to the determined washing cycle is provided. A dishwashing method is also provided.

### CROSS-REFERENCE TO RELATED APPLICATIONS

This application claims priority to Korean Patent Application No. 10-2019-0121303 filed on Oct. 1, 2019 in Korea, the entire contents of which is hereby incorporated by reference in its entirety.

### BACKGROUND

The present disclosure relates to an artificial intelligence dishwasher and a dishwashing method using the same and, more particularly, an artificial intelligence dishwasher capable of efficiently washing dishes using a dish arrangement state and a state of washing water, and a dishwashing method using the same.

Artificial intelligence is a field of computer engineering and information technology for researching a method of enabling a computer to do thinking, learning and self-development that can be done by human intelligence, and means that a computer can imitate a human intelligent action.

In addition, artificial intelligence does not exist in itself but has many direct and indirect associations with the other fields of computer science. In particular, today, attempts to introduce artificial intelligent elements to various fields of information technology to deal with issues of the fields have been actively made.

Meanwhile, technology for recognizing and learning a surrounding situation using artificial intelligence and providing information desired by a user in a desired form or performing a function or operation desired by the user is actively being studied.

An electronic device for providing such operations and functions may be referred to as an artificial intelligence device.

Meanwhile, as the size of a dishwasher gradually increases and the number of dishes to be washed increases, it is necessary to efficiently use the dishwasher.

In general, the dishwasher performs dishwashing according to predetermined dishwashing steps and dishwashing strengths.

In this case, since dishwashing is performed without considering a dishwashing state varying in real time according to the amount, locations, types of dishes to be washed, a lot of energy may be wasted.

Accordingly, there is an increasing need for a dishwasher capable of changing a washing step and washing strength according to the progress of dishwashing.

### SUMMARY

An object of the present disclosure is to solve the above-described problems and the other problems.

Another object of the present disclosure is to provide an artificial intelligence dishwasher and a dishwashing method using the same.

Another object of the present disclosure is to provide an artificial intelligence dishwasher capable of providing a guide to dish arrangement based on a dish arrangement image of dishes arranged on a dish shelf (rack), and a method thereof.

Another object of the present disclosure is to provide an artificial intelligence dishwasher capable of determining a washing cycle based on a value obtained by sensing a state of washing water, and a method thereof.

According to an embodiment, an artificial intelligence dishwasher includes a dish shelf on which dishes are arranged, a spray nozzle configured to spray washing water toward the dishes, a washing pump configured to feed washing water stored in a sump to the spray nozzle, a washing motor configured to drive the washing pump, a camera configured to capture the dish shelf to obtain a dish arrangement image, and a processor configured to provide the dish arrangement image to a dish recognition model to obtain dish information included in the dish arrangement image, determine a washing cycle for the dishes based on the dish information, and control driving of the washing motor according to the determined washing cycle.

According to another embodiment, a dishwashing method includes capturing a dish shelf, on which dishes are arranged, to obtain a dish arrangement image, providing the dish arrangement image to a dish recognition model to obtain dish information included in the dish arrangement image, determining a washing cycle for the dishes based on the dish information, and controlling a dishwasher according to the determined washing cycle to perform dishwashing.

### BRIEF DESCRIPTION OF THE DRAWINGS

FIG. 1 illustrates an AI device according to an embodiment of the present disclosure.

FIG. 2 illustrates an AI server according to an embodiment of the present disclosure.

FIG. 3 illustrates an AI system according to an embodiment of the present disclosure.

FIG. 4 is a view showing an artificial intelligence dishwasher according to an embodiment of the present disclosure.

FIG. 5 is a flowchart illustrating a method of performing dishwashing at an artificial intelligence dishwasher using a dish arrangement image according to an embodiment of the present disclosure.

FIG. 6 is a flowchart illustrating a method of performing dishwashing at an artificial intelligence dishwasher using a sensing value of washing water according to an embodiment of the present disclosure.

FIG. 7 is a view showing an artificial intelligence dishwasher having a camera mounted on a front surface thereof according to an embodiment of the present disclosure.

FIG. 8 is a view showing a process of capturing a dish shelf in a linkage with a door of an artificial intelligence dishwasher according to an embodiment of the present disclosure.

FIG. 9 is a view showing an example of a dish arrangement image before a guide to dish arrangement guide is provided according to an embodiment of the present disclosure.

FIG. 10 is a view illustrating a process of determining dish information and a dish arrangement location from a dish arrangement image at an artificial intelligence dishwasher according to an embodiment of the present disclosure.

FIG. 11 is a view showing an example of a dish arrangement image after a guide to dish arrangement guide is provided according to an embodiment of the present disclosure.

FIG. 12 is a schematic front cross-sectional view of a dishwasher according to one embodiment of the present disclosure.

FIG. 13 is a diagram for describing the flow of electric signals, water, detergent, and air inside the dishwasher according to one embodiment of the present disclosure.

FIG. 14 is a view illustrating a turbidity sensor and an electrical conductivity sensor according to an embodiment of the present disclosure.

FIG. 15 is a view illustrating a process of training a washing cycle determination model according to an embodiment of the present disclosure.

FIG. 16 is a view illustrating a washing cycle determination model according to an embodiment of the present disclosure.

### DETAILED DESCRIPTION OF THE EMBODIMENTS

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the disclosure in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

<Extended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

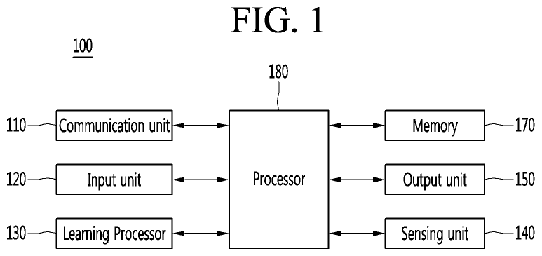

FIG. 1 illustrates an AI device 100 according to an embodiment of the present disclosure.

The AI device (or an AI apparatus) 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

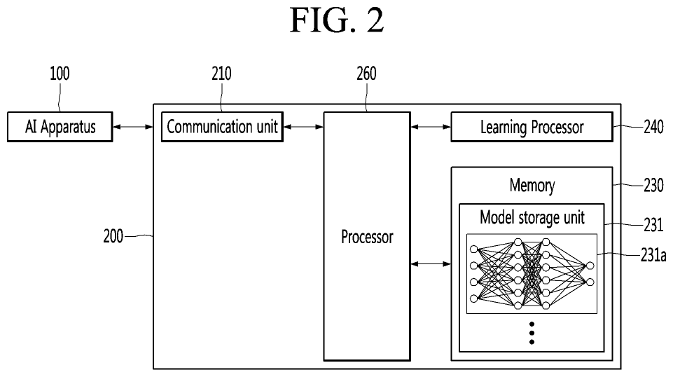

FIG. 2 illustrates an AI server 200 according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

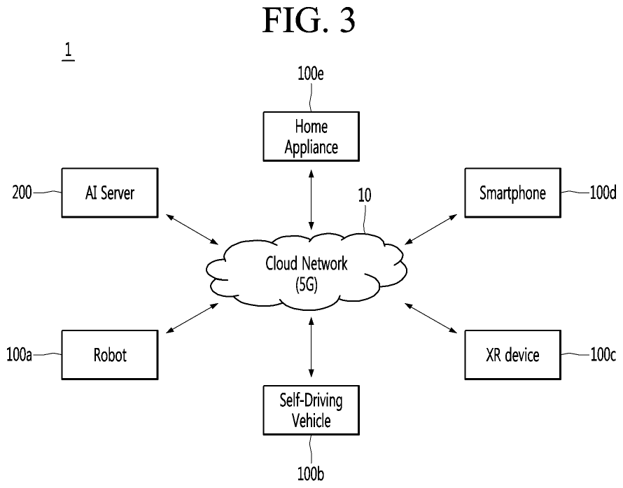

FIG. 3 illustrates an AI system 1 according to an embodiment of he present disclosure.

Referring to FIG. 3, in the AI system at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at east one of he AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At his time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks, The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object, The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

First, artificial intelligence (AI) will be described briefly.

Artificial intelligence (AI) is one field of computer engineering and information technology for studying a method of enabling a computer to perform thinking, learning, and self-development that can be performed by human intelligence and may denote that a computer imitates an intelligent action of a human.

Moreover, AI is directly/indirectly associated with the other field of computer engineering without being individually provided. Particularly, at present, in various fields of information technology, an attempt to introduce AI components and use the Al components in solving a problem of a corresponding field is being actively done.

Machine learning is one field of AI and is a research field which enables a computer to perform learning without an explicit program.

In detail, machine learning may be technology which studies and establishes a system for performing learning based on experiential data, performing prediction, and autonomously enhancing performance and algorithms relevant thereto. Algorithms of machine learning may use a method which establishes a specific model for obtaining prediction or decision on the basis of input data, rather than a method of executing program instructions which are strictly predefined.

The term “machine learning” may be referred to as “machine learning”.

In machine learning, a number of machine learning algorithms for classifying data have been developed. Decision tree, Bayesian network, support vector machine (SVM), and artificial neural network (ANN) are representative examples of the machine learning algorithms.

The decision tree is an analysis method of performing classification and prediction by schematizing a decision rule into a tree structure.

The Bayesian network is a model where a probabilistic relationship (conditional independence) between a plurality of variables is expressed as a graph structure. The Bayesian network is suitable for data mining based on unsupervised learning.

The SVM is a model of supervised learning for pattern recognition and data analysis and is mainly used for classification and regression,

The ANN is a model which implements the operation principle of biological neuron and a connection relationship between neurons and is an information processing system where a plurality of neurons called nodes or processing elements are connected to one another in the form of a layer structure.

The ANN is a model used for machine learning and is a statistical learning algorithm inspired from a neural network (for example, brains in a central nervous system of animals) of biology in machine learning and cognitive science.

In detail, the ANN may denote all models where an artificial neuron (a node) of a network which is formed through a connection of synapses varies a connection strength of synapses through learning, thereby obtaining an ability to solve problems.

The term “ANN” may be referred to as “neural network”.

The ANN may include a plurality of layers, and each of the plurality of layers may include a plurality of neurons. Also, the ANN may include a synapse connecting a neuron to another neuron.

The ANN may be generally defined by the following factors: (1) a connection pattern between neurons of a different layer; (2) a learning process of updating a weight of a connection; and (3) an activation function for generating an output value from a weighted sum of inputs received from a previous layer.

The ANN may include network models such as a deep neural network (ANN), a recurrent neural network (RNN), a bidirectional recurrent deep neural network (BRDNN), a multilayer perceptron (MLP), and a convolutional neural network (CNN), but is not limited thereto.

In this specification, the term “layer” may be referred to as “layer”.

The ANN may be categorized into single layer neural networks and multilayer neural networks, based on the number of layers.

General single layer neural networks is configured with an input layer and an output layer.

Moreover, general multilayer neural networks is configured with an input layer, at least one hidden layer, and an output layer.

The input layer is a layer which receives external data, and the number of neurons of the input layer is the same the number of input variables, and the hidden layer is located between the input layer and the output layer and receives a signal from the input layer to extract a characteristic from the received signal and may transfer the extracted characteristic to the output layer. The output layer receives a signal from the hidden layer and outputs an output value based on the received signal. An input signal between neurons may be multiplied by each connection strength (weight), and values acquired through the multiplication may be summated. When the sum is greater than a threshold value of a neuron, the neuron may be activated and may output an output value acquired through an activation function.

The DNN including a plurality of hidden layers between an input layer and an output layer may be a representative ANN which implements deep learning which is a kind of machine learning technology.

The term “deep learning” may be referred to as “deep learning”.

The ANN may be trained by using training data. Here, training may denote a process of determining a parameter of the ANN, for achieving purposes such as classifying, regressing, or clustering input data, A representative example of a parameter of the ANN may include a weight assigned to a synapse or a bias applied to a neuron.

An ANN trained based on training data may classify or cluster input data, based on a pattern of the input data.

In this specification, an ANN trained based on training data may be referred to as a trained model.

Next, a learning method of an ANN will be described.

The learning method of the ANN may be largely classified into supervised learning, unsupervised learning, semi-supervised learning, and reinforcement learning.

The supervised learning may be a method of machine learning for analogizing one function from training data.

Moreover, in analogized functions, a function of outputting continual values may be referred to as regression, and a function of predicting and outputting a class of an input vector may be referred to as classification.

In the supervised learning, an ANN may be trained in a state where a label of training data is assigned.

Here, the label may denote a right answer (or a result value) to be inferred by an ANN when training data is input to the ANN.

In this specification, a right answer (or a result value) to be inferred by an ANN when training data is input to the ANN may be referred to as a label or labeling data.

Moreover, in this specification, a process of assigning a label to training data for learning of an ANN may be referred to as a process which labels labeling data to training data.

In this case, training data and a label corresponding to the training data may configure one training set and may be inputted to an ANN in the form of training sets.

Training data may represent a plurality of features, and a label being labeled to training data may denote that the label is assigned to a feature represented by the training data. In this case, the training data may represent a feature of an input object as a vector type.

An ANN may analogize a function corresponding to an association relationship between training data and labeling data by using the training data and the labeling data. Also, a parameter of the ANN may be determined (optimized) through evaluating the analogized function.

The unsupervised learning is a kind of machine learning, and in this case, a label may not be assigned to training data.

In detail, the unsupervised learning may be a learning method of training an ANN so as to detect a pattern from training data itself and classify the training data, rather than to detect an association relationship between the training data and a label corresponding to the training data.

Examples of the unsupervised learning may include clustering and independent component analysis.

In this specification, the term “clustering” may be referred to as “clustering”.

Examples of an ANN using the unsupervised learning may include a generative adversarial network (GAN) and an autoencoder (AE).

The GAN is a method of improving performance through competition between two different AIs called a generator and a discriminator.

In this case, the generator is a model for creating new data and generates new data, based on original data.

Moreover, the discriminator is a model for recognizing a pattern of data and determines whether inputted data is original data or fake data generated from the generator.

Moreover, the generator may be trained by receiving and using data which does not deceive the discriminator, and the discriminator may be trained by receiving and using deceived data generated by the generator. Therefore, the generator may evolve so as to deceive the discriminator as much as possible, and the discriminator may evolve so as to distinguish original data from data generated by the generator.

The AE is a neural network for reproducing an input as an output.

The AE may include an input layer, at least one hidden layer, and an output layer.

In this case, the number of node of the hidden layer may be smaller than the number of nodes of the input layer, and thus, a dimension of data may be reduced, whereby compression or encoding may be performed.

Moreover, data outputted from the hidden layer may enter the output layer. In this case, the number of nodes of the output layer may be larger than the number of nodes of the hidden layer, and thus, a dimension of the data may increase, and thus, decompression or decoding may be performed.

The AE may control the connection strength of a neuron through learning, and thus, input data may be expressed as hidden layer data. In the hidden layer, information may be expressed by using a smaller number of neurons than those of the input layer, and input data being reproduced as an output may denote that the hidden layer detects and expresses a hidden pattern from the input data.

The semi-supervised learning is a kind of machine learning and may denote a learning method which uses both training data with a label assigned thereto and training data with no label assigned thereto.

As a type of semi-supervised learning technique, there is a technique which infers a label of training data with no label assigned thereto and performs learning by using the inferred label, and such a technique may be usefully used for a case where the cost expended in labeling is large.

The reinforcement learning may be a theory where, when an environment where an agent is capable of determining an action to take at every moment is provided, the best way is acquired through experience without data.

The reinforcement learning may be performed by a Markov decision process (MDP).

To describe the MDP, firstly an environment where pieces of information needed for taking a next action of an agent may be provided, secondly an action which is to be taken by the agent in the environment may be defined, thirdly a reward provided based on a good action of the agent and a penalty provided based on a poor action of the agent may be defined, and fourthly an optimal policy may be derived through experience which is repeated until a future reward reaches a highest score.

An artificial neural network has a configuration that is specified by a configuration of a model, an activation function, a loss function or a cost function, a learning algorithm, an optimization algorithm, or the like, a hyperparameter may be preset before learning, and then, a model parameter may be set through learning to specify information.

For example, a factor for determining a configuration of the artificial neural network may include the number of hidden layers, the number of hidden nodes included in each hidden layer, an input feature vector, a target feature vector, or the like.

The hyperparameter may include various parameters that need to be initially set for learning, such as an initial value of the model parameter. The model parameter may include various parameters to be determined through learning.

For example, the hyperparameter may include a weight initial value between nodes, a bias initial value between nodes, a size of mini-batch, a number of repetitions of learning, a learning rate, or the like. The model parameter may include a weight between nodes, bias between nodes, or the like.

The loss function can be used for an index (reference) for determining optimum model parameters in a training process of an artificial neural network. In an artificial neural network, training means a process of adjusting model parameters to reduce the loss function and the object of training can be considered as determining model parameters that minimize the loss function.

The loss function may mainly use mean square error (MSE) or cross entropy error (CEE), but the present disclosure is not limited thereto.

The CEE may be used when a correct answer label is one-hot encoded. One-hot encoding is an encoding method for setting a correct answer label value to 1 for only neurons corresponding to a correct answer and setting a correct answer label to 0 for neurons corresponding to a wrong answer.

A learning optimization algorithm may be used to minimize a loss function in machine learning or deep learning, as the learning optimization algorithm, there are Gradient Descent (GD), Stochastic Gradient Descent (SGD), Momentum, NAG (Nesterov Accelerate Gradient), Adagrad, AdaDelta, RMSProp, Adam, and Nadam.

The GD is a technique that adjusts model parameters such that a loss function value decreases in consideration of the gradient of a loss function in the current state.

The direction of adjusting model parameters is referred to as a step direction and the size of adjustment is referred to as a step size.

In this case, the step size may refer to a learning rate.

The GD may partially differentiate the loss function with each of model parameters to acquire gradients and may change and update the model parameters by the learning rate in the acquired gradient direction.

The SGD is a technique that increases the frequency of gradient descent by dividing training data into mini-batches and performing the GD for each of the mini-batches.

The Adagrad, AdaDelta, and RMSProp in the SGD are techniques that increase optimization accuracy by adjusting the step size. The momentum and the NAG in the SGS are techniques that increase optimization accuracy by adjusting the step direction. The Adam is a technique that increases optimization accuracy by adjusting the step size and the step direction by combining the momentum and the RMSProp. The Nadam is a technique that increases optimization accuracy by adjusting the step size and the step direction by combining the NAG and the RMSProp.

The learning speed and accuracy of an artificial neural network greatly depends on not only the structure of the artificial neural network and the kind of a learning optimization algorithm, but the hyperparameters. Accordingly, in order to acquire a good trained model, it is important not only to determine a suitable structure of an artificial neural network, but also to set suitable hyperparameters.

In general, hyperparameters are experimentally set to various values to train an artificial neural network, and are set to optimum values that provide stable learning speed and accuracy using training results.

Hereinafter, an AI device or an artificial intelligence device may be referred to as an AI dishwasher or an artificial intelligence dishwasher.

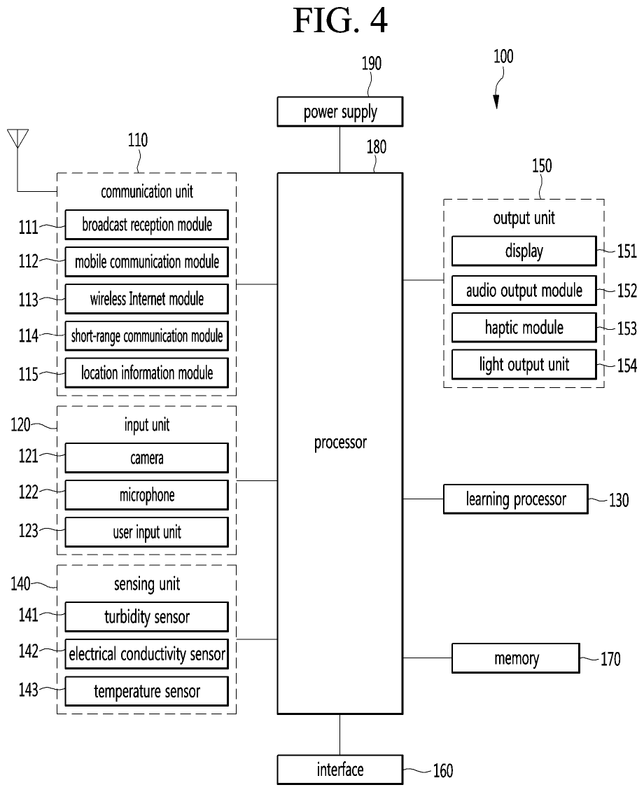

FIG. 4 is a block diagram illustrating an artificial nte gence dishwasher according to the present disclosure.

A description overlapping FIG. 1 will be omitted.

The communication unit 110 may include at least one of a broadcast reception module 111, a mobile communication module 112, a wireless Internet module 113, a short-range communication module 114 and a location information module 115.

The broadcast reception module 111 receives broadcast signals and/or broadcast associated information from an external broadcast management server through a broadcast channel.

The mobile communication module 112 may transmit and/or receive wireless signals to and from at least one of a base station, an external terminal, a server, and the like over a mobile communication network established according to technical standards or communication methods for mobile communication (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE) LTE-A (Long Term Evolution-Advanced), and the like).

The wireless Internet module 113 is configured to facilitate wireless Internet access. This module may be installed inside or outside the artificial intelligence dishwasher 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSUPA), HSUPA (High Speed Uplink Packet Access), Long Term Evolution (LTE), LTE-A (Long Term Evolution-Advanced), and the like.

The short-range communication module 114 is configured to facilitate short-range communication and to support short-range communication using at least one of Bluetooth™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The location information module 115 is generally configured to acquire the position (or the current position) of the artificial intelligence dishwasher. Representative examples thereof include a Global Position System (GPS) module or a Wi-Fi module. As one example, when the artificial intelligence dishwasher uses a GPS module, the position of the artificial intelligence dishwasher may be acquired using a signal sent from a GPS satellite.

The input unit 120 may include a camera 121 for receiving a video signal, a microphone 122 for receiving an audio signal, and a user input unit 123 for receiving information from a user.

The camera 121 may process image frames of still images or moving images obtained by image sensors in a video call more or an image capture mode. The processed image frames can be displayed on the display 151 or stored in memory 170.

The microphone 122 processes an external acoustic signal into electrical audio data. The processed audio data may be variously used according to function (application program) executed in the artificial intelligence dishwasher 100. Meanwhile, the microphone 122 may include various noise removal algorithms to remove noise generated in the process of receiving the external acoustic signal.

The user input unit 123 receives information from a user. When information is received through the user input unit 123, the processor 180 may control operation of the artificial intelligence dishwasher 100 in correspondence with the input information.

The user input unit 123 may include one or more of a mechanical input element (for example, a mechanical key, a button located on a front and/or rear surface or a side surface of the artificial intelligence dishwasher 100, a dome switch, a jog wheel, a jog switch, and the like) or a touch input element. As one example, the touch input element may be a virtual key, a soft key or a visual key, which is displayed on a touchscreen through software processing, or a touch key located at a location other than the touchscreen.

The sensing unit 140 may include a turbidity sensor 141 for measuring turbidity of washing water, an electrical conductivity sensor 142 for measuring electrical conductivity of washing water and a temperature sensor 143 for measuring a temperature of washing water.

The output unit 150 is typically configured to output various types of information, such as audio, video, tactile output, and the like. The output unit 150 may include a display 151, an audio output module 152, a haptic module 153, and a light output unit 154.

The display 151 is generally configured to display (output) information processed in the artificial intelligence dishwasher 100. For example, the display 151 may display execution screen information of an application program executed by the artificial intelligence dishwasher 100 or user interface (UI) and graphical user interface (GUI) information according to the executed screen information.

The display 151 may have an inter-layered structure or an integrated structure with a touch sensor in order to realize a touchscreen. The touchscreen may provide an output interface between the artificial intelligence dishwasher 100 and a user, as well as function as the user input unit 123 which provides an input interface between the artificial intelligence dishwasher 100 and the user.

The audio output module 152 is generally configured to output audio data received from the communication unit 110 or stored in the memory 170 in a call signal reception mode, a call mode, a record mode, a speech recognition mode, a broadcast reception mode, and the like.

The audio output module 152 may also include a receiver, a speaker, a buzzer, or the like.

A haptic module 153 can be configured to generate various tactile effects that a user feels. A typical example of a tactile effect generated by the haptic module 153 is vibration.

A light output unit 154 may output a signal for indicating event generation using light of a light source of the artificial intelligence dishwasher 100. Examples of events generated in the artificial intelligence dishwasher 100 may include message reception, call signal reception, a missed call, an alarm, a schedule notice, email reception, information reception through an application, and the like.

The interface 160 serves as an interface with external devices to be connected with the artificial intelligence dishwasher 100. The interface 160 may include wired or wireless headset ports, external power supply ports, wired or wireless data ports, memory card ports, ports for connecting a device having an identification module, audio input/output (I/O) ports, video I/O ports, earphone ports, or the like. The artificial intelligence dishwasher 100 may perform appropriate control related to the connected external device in correspondence with connection of the external device to the interface 160.

The identification module may be a chip that stores a variety of information for granting use authority of the artificial intelligence dishwasher 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the artificial intelligence dishwasher 100 via the interface 160.

The power supply 190 receives external power or internal power and supplies the appropriate power required to operate respective components included in the artificial intelligence dishwasher 100, under control of the controller 180.

Meanwhile, as described above, the processor 180 controls operation related to the application program and overall operation of the artificial intelligence dishwasher 100. For example, the processor 180 may execute or release a lock function for limiting input of a control command of the user to applications when the state of the artificial intelligence dishwasher satisfies a set condition.

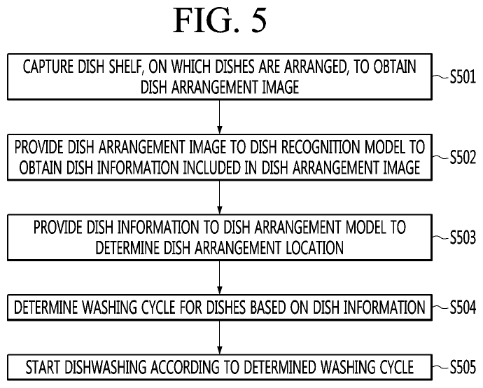

FIG. 5 is a flowchart illustrating a method of performing dishwashing at an artificial intelligence dishwasher 100 using a dish arrangement image according to an embodiment of the present disclosure.

The camera 121 may capture a wash arrangement shelf on which dishes are arranged, thereby obtaining a dish arrangement image (S501).

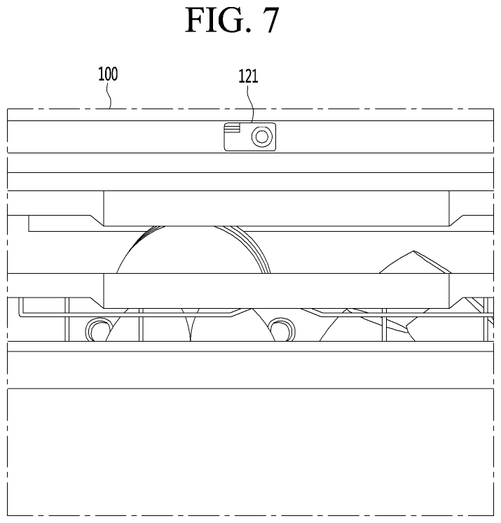

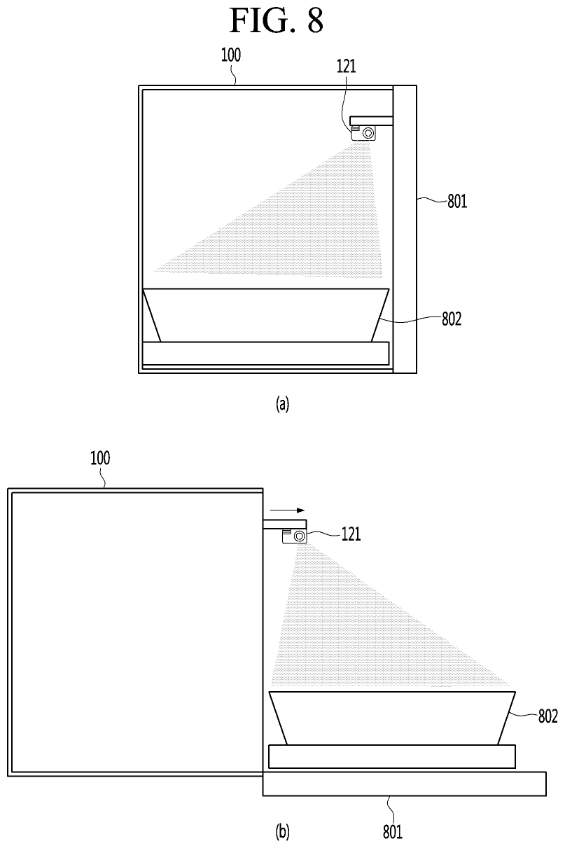

Referring to FIGS. 7 and 8, the camera 121 may be located at a place where the dish shelf may be captured by opening a door of the artificial intelligence dishwasher 100. For example, the camera may be located on the upper end of the front surface of the artificial intelligence dishwasher 100.

In addition, the camera 121 may move to the outside of the artificial intelligence dishwasher 100 to capture the dish shelf 802 located outside when the dish shelf 802 is discharged to the outside of the artificial intelligence dishwasher 100 while the door 801 of the artificial intelligence dishwasher 100 is opened.

Accordingly, while a user who uses the artificial intelligence dishwasher 100 opens the door 801 to arrange dishes on the dish shelf 802, the dishes arranged on the dish shelf 802 may be captured. The artificial intelligence dishwasher 100 may provide a guide to dish arrangement using the dish arrangement image even while the user arranges the dishes.

In addition, the camera 121 may move to the inside of the artificial intelligence dishwasher 100 to capture the dish shelf 802 located at the inside, when the dish shelf 802 moves to the inside of the artificial intelligence dishwasher 100 while the door 801 of the artificial intelligence dishwasher 100 is closed.

Accordingly, when the user who uses the artificial intelligence dishwasher 100 closes the door 801 to start dishwashing, the dishes arranged on the dish shelf 802 may be captured. The artificial intelligence dishwasher 100 may provide a guide to correct dish arrangement using the captured dish arrangement image even if the user completes dish arrangement.

In addition, the camera 121 may capture the dishes arranged on each dish shelf even if there is a plurality of dish shelves.

The processor 180 may provide the dish arrangement image to a dish recognition model to obtain dish information included in the dish image (S502).

In addition, the processor 180 may provide the dish information to the dish arrangement model to determine a dish arrangement location (S503).

The dish recognition model and the dish arrangement model may be artificial neural network (ANN) models used in machine learning. A speech correction model may be composed of artificial neurons (nodes) that form a network by synaptic connections. The speech correction model can be defined by a connection pattern between neurons in different layers, a learning process for updating model parameters, and an activation function for generating an output value.

The dish recognition model and the dish arrangement model may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

The dish recognition model and the dish arrangement model may be generated via supervised learning, unsupervised learning, and reinforcement learning according to a learning method.

For example, if the dish recognition model and the dish arrangement model are generated via supervised learning, learning may be performed in a state in which a label for training data is given. The label may mean the correct answer (or result value) that the artificial neural network should infer when the training data is input to the artificial neural network.

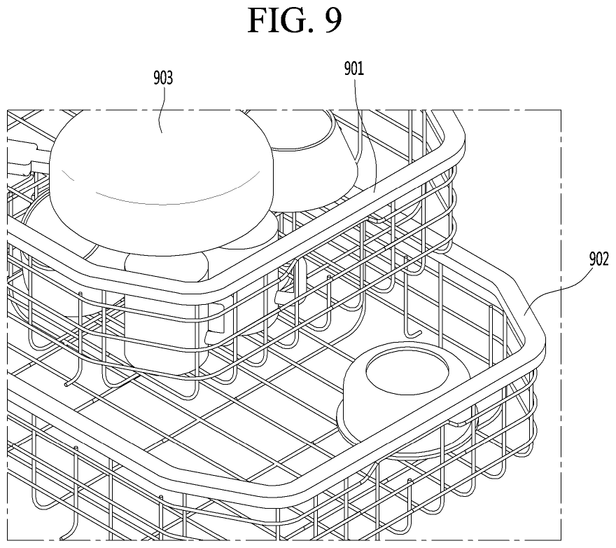

The dish recognition model and the dish arrangement model will be described with reference to FIGS. 9 to 11.

FIG. 9 is a view showing an example of a dish arrangement image before a guide to dish arrangement guide is provided according to an embodiment of the present disclosure.

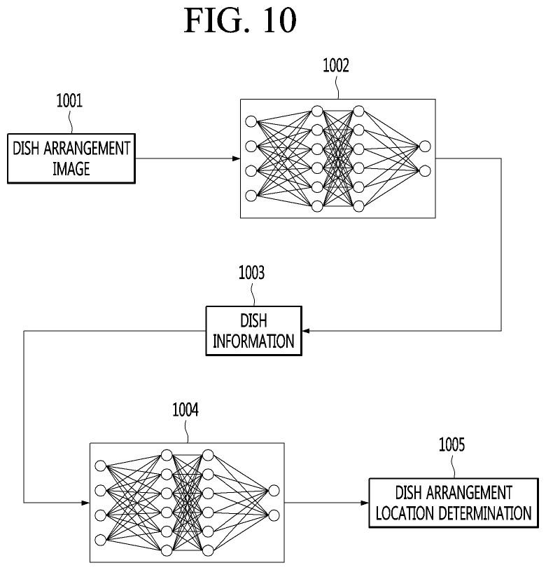

FIG. 10 is a view illustrating a process of determining dish information and a dish arrangement location from a dish arrangement image at an artificial intelligence dishwasher 100 according to an embodiment of the present disclosure.

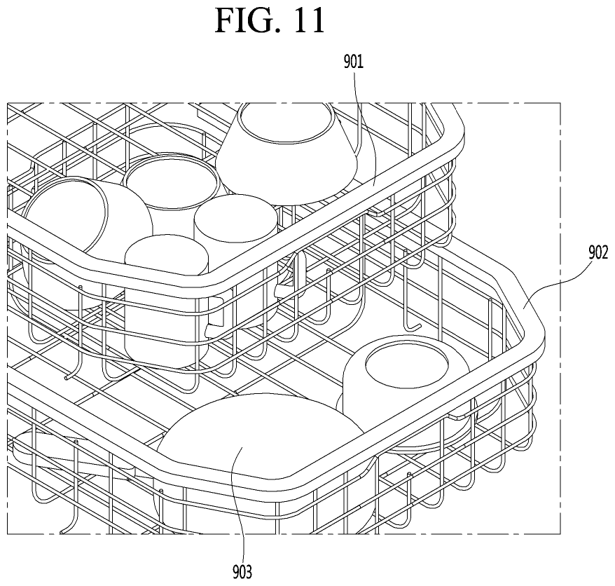

FIG. 11 is a view showing an example of a dish arrangement image after a guide to dish arrangement guide is provided according to an embodiment of the present disclosure.

The dish recognition model may be a neural network learned using a machine learning algorithm or a deep learning algorithm such that, when a predetermined image is input, dish information including the number, types and locations of dishes included in the predetermined image is output.

The dish recognition model may output the dish information including information on at least one of a dish area location of each recognized dish, a location of an area, in which no dish is arranged, a contour of a dish, a dish type or the number of recognized dishes, using the dish arrangement image obtained by capturing at least one dish as input data.

In addition, in the case of the dish arrangement image obtained by capturing dishes arranged on a plurality of dish shelves, the dish recognition model may output dish information including information on at least one of a location of each dish arranged in each dish shelf, a dish contour, a dish type or the number of recognized dishes.

For example, the dish information may include information on recognized first and second dishes. The information on the first dish may be {“dish type”: “cup”, “dish location”: {arrangement shelf: “first dish shelf” “top”: “141”, “left”: “356”, “width”: “123,” “height”: “123”). The information on the second dish may be {“dish type”: “frying fan”, “dish location”: {arrangement shelf: “second dish shelf” “top”: “15”, “left”: “115”, “width”: “245”, “height”: “263”). In addition, the dish information may include information indicating that the number of recognized dishes is “11”. Accordingly, the processor 180 may obtain information on the dishes arranged on the dish shelf.

Referring to FIGS. 9 and 10, the camera 120 may capture the dishes arranged on a first dish shelf 901 and a second dish shelf 902, and the processor 180 may obtain a captured dish arrangement image 1001.

In addition, the processor 180 may provide the dish arrangement image 1001 to the dish recognition model 1002, thereby obtaining the dish information 1003,

The dish information 1003 may include information on the dishes arranged on the first dish shelf 901 and the second dish shelf 903.

For example, the dish information 1003 may include information indicating that a frying fan 903 is arranged on the first dish shelf 901.

In addition, the dish information may include the location of the area in which no dish is arranged on the dish shelf.

Meanwhile, the dish arrangement model may be a neural network trained using a machine learning algorithm or a deep learning algorithm such that, when predetermined dish information is input, the arrangement location of each dish is output.

The processor 180 may obtain the arrangement location of each dish such that the artificial intelligence dishwasher 100 washes dishes to be washed using the dish arrangement model.

Referring to FIG. 10, the processor 180 may provide the dish information 1003 to the dish arrangement model 1004 to obtain a dish arrangement location 1005 and determine a dish arrangement location where efficient washing is possible.

For example, if the dish information 1003 includes information on the frying fan 903 arranged on the first dish shelf 901 and information on the location of the area, in which no dish is arranged on the second dish shelf 902, the dish arrangement model may output the arrangement location of the frying fan 903 as the location of the area, in which no dish is arranged, of the second dish shelf 902. The processor 180 may determine the arrangement location of the frying fan 903 as the location of the area, in which no dish is arranged, of the second frying arrangement shelf 902.

In addition, the speaker included in the audio output unit 152 may output a voice guidance message for dishes having changed arrangement locations. Accordingly, the processor 180 may output a voice guidance message for the frying fan 903 having the changed arrangement location via the speaker.

In addition, the processor 180 may determine a washing cycle for dishes based on the dish information (S504).

The washing cycle may include operation information related to washing, rinsing and drying, operation information related to drainage, water supply, preliminary washing, main washing, heating washing or stopping, washing course, the amount of detergent to be put and a washing strength.

For example, the processor 180 may obtain the number of dishes based on the dish information, and determine a washing cycle such that the washing strength increases as the number of dishes increases. In addition, when there is a dish used for cooking, such as a frying fan, based on the dish information, the processor 180 may determine a washing cycle as a washing course for the dish used for cooking.

The processor 180 may control the dishwasher according to the determined washing cycle to perform dishwashing (S505).

The processor 180 may control driving of a washing motor according to the determined washing cycle.

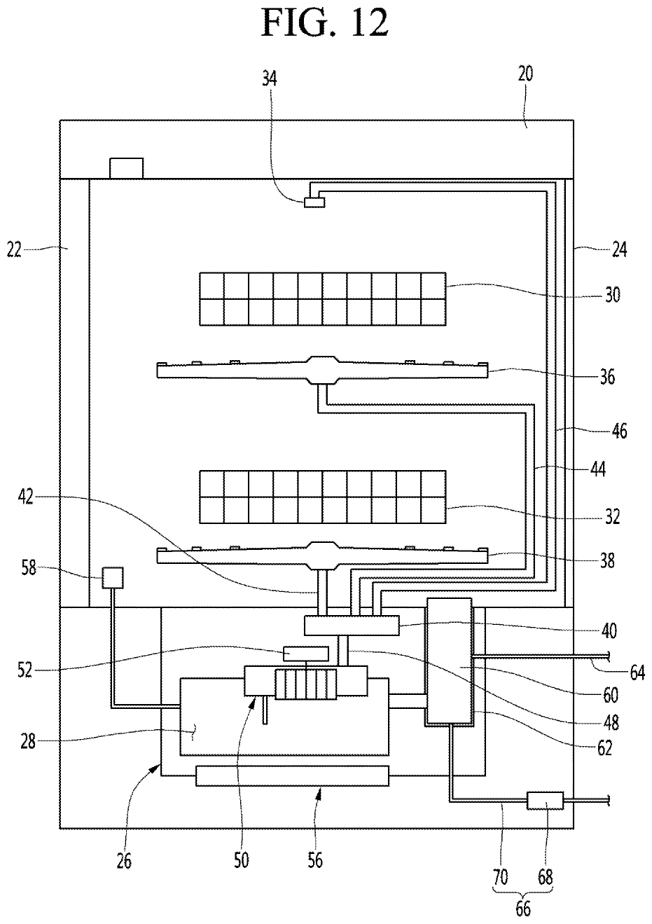

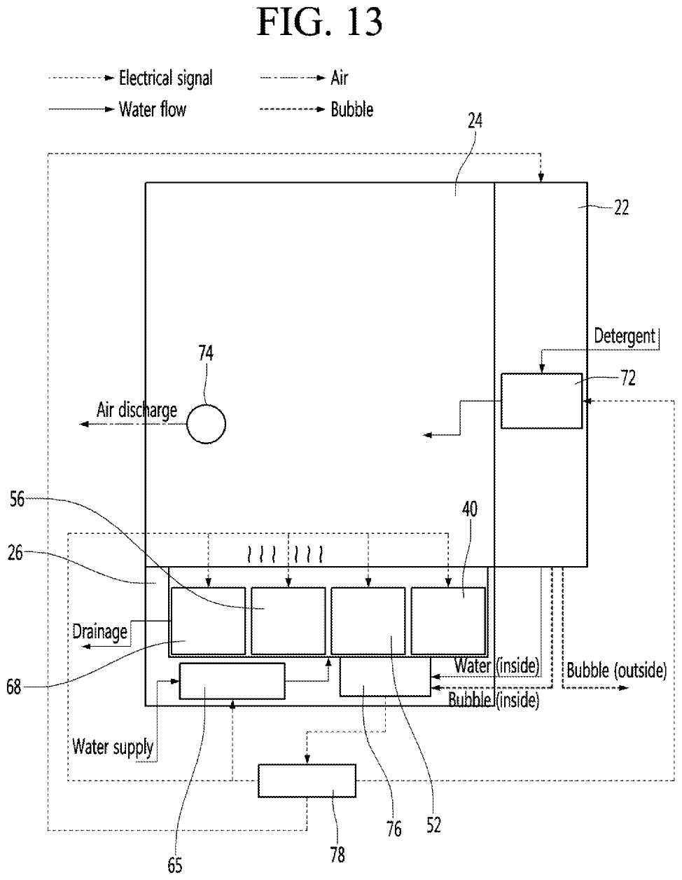

Meanwhile, the artificial intelligence dishwasher 100 according to the embodiment of the present disclosure will be described with reference to FIGS. 12 and 13.

FIG. 12 is a schematic front cross-sectional view of the artificial intelligence dishwasher according to one embodiment of the present disclosure.

FIG. 13 is a diagram for describing the flow of electric signals, water, detergent, and air inside the dishwasher according to one embodiment of the present disclosure.

Hereinafter, the configuration of the artificial intelligence dishwasher according to the present embodiment and the flow of current and water therein will be described with reference to FIGS. 12 and 13.

Referring to FIG. 12, the artificial intelligence dishwasher according to the embodiment of the present disclosure includes a cabinet 20 forming an appearance, a door 22 coupled to the cabinet 20 to open or close the inside of the cabinet 20, and a tub 24 installed inside the cabinet 20 to apply washing water or steam thereto.

The artificial intelligence dishwasher according to the present embodiment may include a dispenser 72 for storing the detergent supplied by the user and supplying the detergent into the tub 24 in the cleaning operation. The dispenser 72 may be disposed on the door 22.

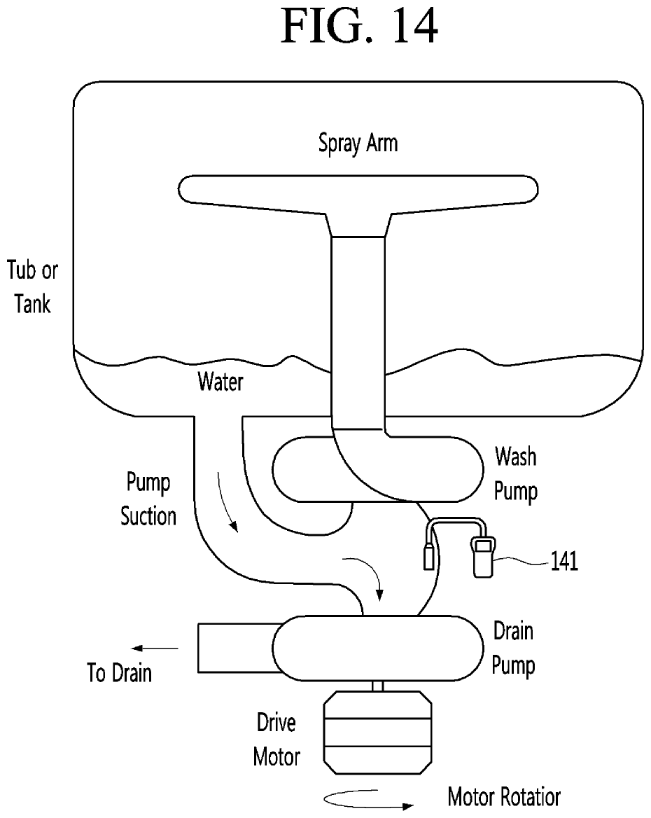

The tub 24 is a space in which dishes are placed for cleaning the dishes. The tub 24 according to the present embodiment may form an air guide hole 74 (see FIG. 14) on one side so as to discharge air to the outside to reduce the pressure when the internal pressure increases.

The artificial intelligence dishwasher according to the present embodiment includes racks 30 and 32 for accommodating dishes in the tub 24, spray nozzles 34, 36, and 38 for spraying washing water toward the dishes accommodated in the racks 30 and 32, a sump 26 for supplying washing water to the spray nozzles 34, 36, and 38, a washing pump 50 for feeding the washing water stored in the sump 26 to the spray nozzles 34, 36, and 38, and supply pipes 42, 44, and 46 connecting the washing pump 50 and the spray nozzles 34, 36, and 38.

The dishwasher further includes a washing motor 52 for driving the washing pump 50. The washing motor 52 may be a brushless direct current (BLDC) motor capable of controlling the rotation speed. Since the washing motor 52 is a BLDC motor, it is possible to set a target revolution per minute (RPM), When the RPM of the BLDC motor is changed, the pressing force of the washing pump 50 changes.

Even when the RPM of the BLDC motor is the same, the amount of the washing water supplied to the sump may be different, or the current value may be changed according to the kind of fluid supplied to the sump. That is, even when the washing motor 52 rotates at the same RPM, the current value applied to the washing motor 52 may change according to whether the fluid supplied to the sump is water, air, or foam.

The dishwasher according to the present embodiment may further include a water supply module 60 for supplying water to the sump 26 or the spray module, a drainage module connected to the sump 26 to discharge the washing water to the outside, a filter assembly 70 provided in the sump 26 to filter the washing water, and a heater 56 provided in the sump 26 to heat the washing water.

The racks 30 and 32 are provided in the tub 24 to accommodate objects to be cleaned, such as dishes.

The racks 30 and 32 may be referred to as dish shelves.

In the present embodiment, the dishwasher includes at least one rack 30 and 32. The racks 30 and 32 according to the present embodiment include a lower rack 32 disposed at the lower portion inside the tub 24 and an upper rack 30 disposed above the lower rack 32.

The dishwasher according to the present embodiment includes at least one spray nozzle 34, 36, and 38. The dishwasher according to the present embodiment includes a lower nozzle 38 provided in the tub 24 to wash the object to be cleaned, which is accommodated in the lower rack 32, an upper nozzle 36 disposed to clean the object to be cleaned, which is accommodated in the upper rack 30, and a top nozzle 34 disposed at the uppermost portion of the tub 24 to spray washing water.

The supply pipes 42, 44, and 46 according to the present embodiment connect the sump 26 and the spray nozzles 34, 36, and 38, When the washing pump 50 is operated to pump the cleaning water stored in the sump 26, the washing water is supplied to the spray nozzles 34, 36, and 38. The supply pipes 42, 44, and 46 according to the present embodiment include a first pipe 42 for supplying washing water to the lower nozzle 38, a second pipe 44 for supplying washing water to the upper nozzle 36, and a third pipe 46 for supplying washing water to the top nozzle 34.

The dishwasher according to the present embodiment includes a flow path switching portion 40 for supplying the washing water stored in the sump 26 to the first to third pipes 42 to 46.

The flow path switching portion 40 according to the present embodiment may include a flow path switching motor (not illustrated) for generating a rotating force and a rotary plate (not illustrated) rotated by the flow path switching motor to adjust the flow of the washing water. The rotary plate according to the present embodiment may selectively open or close a plurality of connection ports (not illustrated) formed at a location where the plurality of supply pipes 42, 44, 46 are branched. A plurality of switching holes (not illustrated) may be formed in the rotary plate. The rotary plate is rotated stepwise by the flow path switching motor. When the rotary plate is rotated by the flow path switching motor, the plurality of switching holes formed in the rotary plate are located at positions corresponding to at least one of the plurality of connection ports so that the washing water flowing from the washing pump 50 is sprayed toward at least one of the plurality of spray nozzles 34.

The flow path switching motor according to the present embodiment generates a rotating force to rotate the rotary plate stepwise. The flow path switching motor is preferably a step motor that advances by a predetermined angle whenever an excitation state changes to an input pulse signal, and stops and maintains a predetermined position when the excitation state does not change.

The washing water discharged from the sump 26 through the washing pump 50 is transferred to the flow path switching portion 40 through a pump pipe 48, The flow path switching portion 40 may supply the washing water introduced from the sump to each of the first to third pipes 42 to 46 or at least two pipes thereof.

The upper nozzle 36 may be positioned below the upper rack 30. The upper nozzle 36 is preferably rotatably coupled to the second tube 44 so that the upper nozzle 36 is rotated by the repulsive force of the washing water when the washing water is sprayed.

The top nozzle 34 is disposed at a position higher than the upper rack 30. The top nozzle 34 is disposed on the upper side of the tub 24. The top nozzle 34 receives washing water from the third pipe 46 to spray the washing water into the upper rack 30 and the lower rack 32.

In the present embodiment, the spray nozzles 34, 36, and 38 are configured to receive the washing water from the sump 26 in which the washing water is stored, and spray the washing water. However, unlike the present embodiment, the spray nozzles 34, 36, and 38 are configured to directly receive water through the water supply module 60.

The water supply module 60 is configured to receive water from the outside to supply the water to the sump 26. The water supply module 65 opens or closes the water supply valve 65 to supply outside water into the sump 26. In the present embodiment, water is supplied to the sump 26 via the filter assembly 70. The drainage module is provided for discharging the washing water stored in the sump 26 to the outside, and includes a drainage flow path 64 and a drainage pump 66.

The filter assembly 70 is provided for filtering foreign matter such as food waste contained in the washing water, and is disposed on the flow path of the washing water introduced from the tub 24 into the sump 26.

To this end, the sump 26 may be provided with a filter mounting portion 62 on which the filter assembly 70 is installed, and a filter flow path connecting the filter mounting portion and the inside of the sump 26 may be disposed.

The sump 26 may include a steam nozzle 58 for spraying the steam generated by the heater 56 into the tub 24, and a valve (not illustrated) connected to the steam nozzle 58 through the steam path for interrupting steam may be installed in a steam flow path to interrupt the steam sprayed into the tub 24 through the valve. In some cases, the sump 26 may adjust the amount of steam.

The steam generated in the sump 26 may be supplied to the inside of the tub 24 through the filter flow path and the filter mounting portion 62, instead of the steam nozzle. The sump 26 may be connected to the tub 24 in both directions through the steam flow path and the filter flow path.

The electrical control of the internal configuration of the dishwasher, the flow of air inside the dishwasher, and the flow of water and foam are described with reference to FIG. 13.

The dishwasher according to the present embodiment is provided with a control panel (not illustrated) for allowing the user to select and control the function of the dishwasher. A control unit 78 including a circuit for operating the dishwasher and a printed circuit board (PCB) having various electric devices mounted thereon is provided inside the control panel.

The PCB is electrically connected to the configuration inside the dishwasher, and the control unit 78 may control the configuration inside the dishwasher through the PCB. The control unit 78 may supply the washing water into the tub 24 by opening or closing the water supply valve 65. The control unit 78 may operate the heater 56 to heat the washing water stored in the sump 26. The control unit 78 may operate the washing pump 50 to circulate the washing water stored in the sump 26 inside the tub 24. The control unit 78 controls the flow path switching portion 40 to supply the washing water supplied from the washing pump 50 to at least one of the spray nozzles. The control unit 78 may adjust the position of the rotary plate by driving the flow path switching motor. The control unit 78 may open or close the water supply valve 65 to supply water into the sump 26. The control unit 78 may operate the drainage pump 68 to drain the washing water in the tub 24. The control unit 78 may detect whether the door 22 is open or closed or may detect whether to open or close the door 22. The control unit 78 may open the dispenser 72 to introduce the detergent into the tub 24. The control unit 78 may detect the level of the water in the tub 24 by detecting the elevation height of the floater 76.

Referring to FIG. 13, the detergent may be introduced into the dispenser 72 by the user, and the detergent stored in the dispenser 72 may be introduced into the tub 24 during the washing process of the dishwasher and mixed with the washing water.

Referring to FIG. 13, when the water supply valve 65 is opened, washing water flows into the sump 26 from the outside. The washing water may be circulated in the tub 24 by the washing pump 50 and discharged outside the dishwasher by the operation of the drainage pump 68. The washing water circulating in the tub 24 passes through the water level detection unit, and the water level detection sensor or the floater 76 may detect whether the washing water exceeds the storage space inside the sump.

The washing water is a concept including water supplied from the outside, washing water mixed with detergent during washing, and rinse water used in the rinse process.

FIG. 14 is a view illustrating a turbidity sensor and an electrical conductivity sensor according to an embodiment of the present disclosure.

The turbidity sensor and the electrical conductivity sensor may be located in a tank for storing washing water or a passage through which washing water moves.

Meanwhile, the turbidity sensor and the electrical conductivity sensor may be located in a sump 26 in order to measure the turbidity and electrical conductivity of the washing water stored in the sump 26.

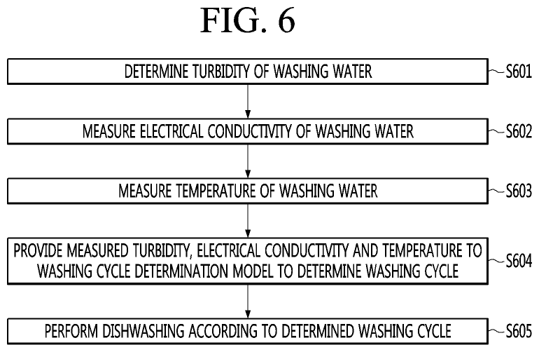

FIG. 6 is a flowchart illustrating a method of performing dishwashing at an artificial intelligence dishwasher 100 using a dish arrangement image according to an embodiment of the present disclosure.

The turbidity sensor may include one or more turbidity sensing modules and measure the turbidity of washing water (S601).

The electrical conductivity sensor may measure the electrical conductivity of washing water (S602).

A temperature sensor may include one or more temperature sensing modules and measure the temperature of washing water (S603).

The processor 180 may correct an electrical conductivity value according to the measured temperature. For example, the processor 180 may correct the measured electrical conductivity based on the temperature using an electrical conductivity correction algorithm

The electrical conductivity sensor may measure the electrical conductivity of washing water, by applying constant voltages to two electrodes and detecting the level of flowing current. Electrical conductivity may indicate the amount of material dissolved in washing water. Since the electrical conductivity of a solution may be affected by the temperature of the solution in addition to the dissolved material, the processor 18 may correct the measured electrical conductivity according to the temperature.

The processor 180 may provide the measured turbidity, electrical conductivity and temperature to a washing cycle determination model to determine a washing cycle (S604).

The processor 180 may correct the measured electrical conductivity based on the measured temperature and provide the corrected electrical conductivity to the washing cycle determination model, thereby determining the washing cycle.

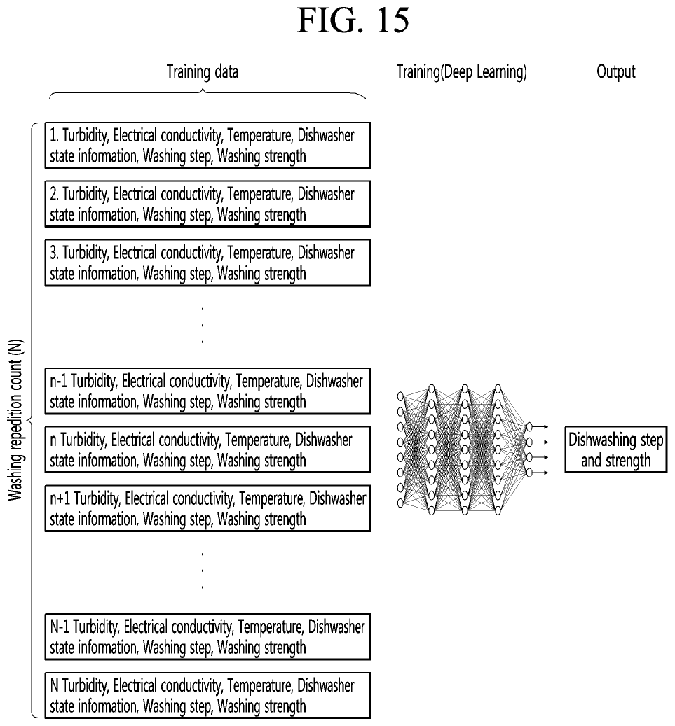

FIG. 15 is a view illustrating a process of training a washing cycle determination model according to an embodiment of the present disclosure.

The washing cycle determination model may be a neural network trained using a machine learning algorithm or a deep learning algorithm for determining a dishwashing step and a dishwashing strength of a predetermined dishwasher, when the turbidity, electrical conductivity and temperature of washing water measured whenever washing of the predetermined dishwasher is repeated and dishwasher state information are input.

The washing cycle determination model may be a neural network trained using a machine learning algorithm or a deep learning algorithm for determining the washing cycle of a predetermined dishwasher, when sensing information including at least one of the turbidity, electrical conductivity or temperature of washing water measured whenever washing of the predetermined dishwasher is repeated is input.

The dishwasher state information may include at least one of a time required to supply water, a time required to drain water, power off information, a spray level according a turbidity detection value, whether a low voltage is generated, a door open history during operation, whether lack of salt is detected, whether lack of rinse is detected, a motor RPM value at the time of drainage, occurrence error information, a course set by a user, HalfLoad set by the user, pre-steam set by the user, or a hardness level set by the user.

The washing cycle determination model may receive the turbidity and electrical conductivity of washing water measured whenever washing is repeated, and output a washing cycle including a dishwashing step to be currently performed by the dishwasher and a dishwashing strength.

The dishwashing step may include an operation step related to washing, rinsing and drying and an operation step related to drainage, water supply, preliminary washing, main washing, heating washing or stopping.

For example, the artificial intelligence dishwasher 100 may wash dishes in a preliminary washing step.

Since the turbidity and electrical conductivity of washing water may be changed whenever preliminary washing is repeated, the processor 180 may provide the turbidity and electrical conductivity of washing water to the washing cycle determination model and determine whether to transition to the main washing step.

For example, if scraps of the dish are sufficiently filtered out in the preliminary washing step, since the scraps of washing water may be reduced and turbidity may be reduced. In this case, the washing cycle determination model may output transition from the preliminary washing step to the main washing step.

In addition, for example, if scraps of the dish continue to occur in the preliminary washing step, the scraps of washing water may be constantly maintained and turbidity may be constantly maintained. In this case, the washing cycle determination model may output increase in washing strength.

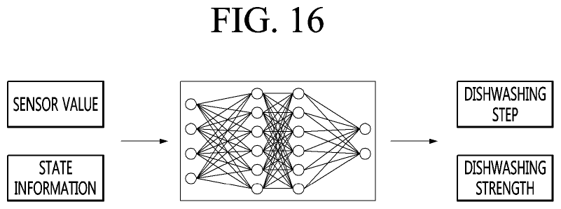

FIG. 16 is a view illustrating a washing cycle determination model according to an embodiment of the present disclosure.

The processor 180 may provide sensing information including the turbidity, electrical conductivity and temperature of washing water and the dishwasher state information to the washing cycle determination model, thereby obtaining the dishwashing step and the dishwashing strength.

The processor 180 may determine whether the washing cycle including the dishwashing step and the dishwashing strength has been changed and control an artificial intelligence dishwasher according to the changed washing cycle, thereby performing dishwashing.

According to various embodiments of the present disclosure, an artificial intelligence dishwasher can provide a guide to a dish arrangement location when a user arranges dishes on a dish shelf.

According to various embodiments of the present disclosure, the artificial intelligence dishwasher can automatically control a washing step and strength using a sensing value of washing water when dishwashing is performed.

According to various embodiments of the present disclosure, the artificial intelligence dishwasher can conserve energy by efficiently changing a washing cycle.

The present disclosure may be embodied as computer-readable codes on a program-recorded medium. The computer-readable recording medium may be any recording medium that can store data which can be thereafter read by a computer system. Examples of the computer-readable medium may include a hard disk drive (HDD), a solid state disk (SSD), a silicon disk drive (SDD), a ROM, a RAM, a CD-ROM, a magnetic tape, a floppy disk, and an optical data storage device. The computer may also include the control unit 180 of the server.

What is claimed is:

1. An artificial intelligence dishwasher, comprising:
a dish rack to support dishes thereon;
a spray nozzle to spray washing water toward the dishes;
a sump to store the washing water;
a washing pump to direct the washing water stored in a sump to the spray nozzle;
a washing motor configured to drive the washing pump;
a camera configured to capture an image of the dish rack to obtain a dish arrangement image; and
a processor configured to:
provide the dish arrangement image to a dish recognition model to obtain dish information included in the dish arrangement image;
determine a washing cycle for the dishes based on the dish information; and
control driving of the washing motor according to the determined washing cycle.

2. The artificial intelligence dishwasher of claim 1, wherein the dish recognition model is a neural network trained using a machine learning algorithm or a deep learning algorithm such that, when the dish arrangement image is input to the dish recognition model, dish information including information on a number, a type and a location of the dishes included in the dish arrangement image is output.

3. The artificial intelligence dishwasher of claim 1, wherein the processor is configured to provide the dish information to a dish arrangement model to determine a dish arrangement location for each dish of the dishes, and
wherein the artificial intelligence dishwasher further includes a speaker configured to output a voice guidance message to a user indicating if one dish of the dishes should be moved to the dish arrangement location for the one dish.

4. The artificial intelligence dishwasher of claim 3, wherein the dish arrangement model is a neural network trained using a machine learning algorithm or a deep learning algorithm such that, when the dish information is input to the dish arrangement model, an arrangement location for each dish of the dishes is output.

5. The artificial intelligence dishwasher of claim 1, further comprising:
a turbidity sensor configured to measure turbidity of the washing water; and
an electrical conductivity sensor configured to measure electrical conductivity of the washing water,
wherein the processor is further configured to provide the measured turbidity and electrical conductivity to a washing cycle determination model to provide the determined washing cycle.

6. The artificial intelligence dishwasher of claim , further comprising a temperature sensor configured to measure a temperature of the washing water,
wherein the processor is further configured to:
correct the measured electrical conductivity based on the measured temperature; and
provide the corrected electrical conductivity to the washing cycle determination model to provide the determined washing cycle.

7. The artificial intelligence dishwasher of claim 6, wherein the washing cycle determination model is a neural network trained using a machine learning algorithm or a deep learning algorithm to determine a washing cycle of a predetermined dishwasher when sensing information including at least one of the turbidity, electrical conductivity or temperature of the washing water measured whenever washing by the predetermined dishwasher is repeated is input.

8. The artificial intelligence dishwasher of claim 1, wherein the camera is moveable relative to the rack.

9. The artificial intelligence dishwasher of claim 8, wherein the artificial intelligence dishwasher includes:
a cabinet, the cabinet having an opening for placing the dishes on the rack; and
a door for opening and closing the opening of the cabinet,
wherein the camera is moveable through the opening of the cabinet, and
wherein the rack is moveable through the opening such that the camera can obtain the dish arrangement image of the rack when it is moved through the opening.

10. The artificial intelligence dishwasher of claim 9, wherein the rack is a first rack, and
wherein the artificial intelligence dishwasher further comprises a second rack, the second rack being moveable into and out of the cabinet,

11. A dishwashing method of an artificial intelligence dishwasher, the dishwashing method comprising:
capturing an image of a dish rack on which dishes are arranged to obtain a dish arrangement image;
providing, by a processor of the artificial intelligence dishwasher, the dish arrangement image to a dish recognition model to obtain dish information included in the dish arrangement image;
determining a washing cycle for the dishes based on the dish information; and
controlling, by the processor, the artificial intelligence dishwasher according to the determined washing cycle to perform dishwashing.

12. The dishwashing method of claim 11, wherein the dish recognition model is a neural network trained using a machine learning algorithm or a deep learning algorithm such that, when the dish arrangement image is input to the dish recognition model, dish information including information on a number, a type and a location of the dishes included in the dish arrangement image is output.

13. The dishwashing method of claim 11, further comprising:
providing the dish information to a dish arrangement model to determine a dish arrangement location for each dish of the dishes, and
outputting a voice guidance message to a user indicating if one dish of he dishes should be moved to the dish arrangement location for the one dish.

14. The dishwashing method of claim 13, wherein the dish arrangement model is a neural network trained using a machine learning algorithm or a deep learning algorithm such that, when the dish information is input to the dish arrangement model, an arrangement location for each dish of the dishes is output,

15. The dishwashing method of claim 11, wherein, controlling, by the processor, the artificial intelligence dishwasher according to the determined washing cycle to perform dishwashing includes spraying washing water toward the dishes using a spray nozzle, and
wherein the dishwashing method further includes:
measuring turbidity of the washing water;
measuring electrical conductivity of the washing water; and
providing, by the processor of the artificial intelligence dishwasher, the measured turbidity and electrical conductivity to a washing cycle determination model to provide the determined washing cycle.

16. The dishwashing method of claim 15, further comprising:
measuring a temperature of the washing water;
correcting the measured electrical conductivity based on the measured temperature; and
providing, by the processor of the artificial intelligence dishwasher, the corrected electrical conductivity to the washing cycle determination model to provide the determined washing cycle.

17. The dishwashing method of claim 16, wherein the washing cycle determination model is a neural network trained using a machine learning algorithm or a deep learning algorithm o determine a washing cycle of a predetermined dishwasher when sensing information including at least one of the turbidity, electrical conductivity or temperature of the washing water measured whenever washing by the predetermined dishwasher is repeated is input.

18. The dishwashing method of claim 11 wherein the artificial intelligence dishwasher includes a camera that is movable relative to the rack to obtain the dish arrangement image.

19. The dishwashing method of claim 18, wherein the artificial intelligence dishwasher includes:
a cabinet, the cabinet having an opening for placing the dishes on the rack; and
a door for opening and closing the opening of the cabinet,
wherein the camera is moveable through the opening of the cabinet, and
wherein the rack is moveable through the opening such that the camera can obtain the dish arrangement image of the rack when it is moved through the opening.

20. The dishwashing method of claim 19, wherein the rack is a first rack and the dish arrangement image is a first dish arrangement image, and
wherein the dishwashing method further comprises:
providing a second rack, the second rack being moveable into and out of the cabinet; and
capturing a second dish arrangement image of the second rack.
